(19) United States
(12) Patent Application Publication
(10) Pub. No.: US 2013/0138852 A1
(43) Pub. Date: May 30, 2013

(54) ELECTRONIC DEVICE WITH BASEBOARD MANAGEMENT CONTROLLER

(71) Applicant: HSIU-HUI PENG, Tu-Cheng (TW)

(72) Inventor: HSIU-HUI PENG, Tu-Cheng (TW)

(73) Assignee: HON HAI PRECISION INDUSTRY CO., LTD., Tu-Cheng (TW)

(21) Appl. No.: 13/340,613

(22) Filed: Dec. 29, 2011

(30) Foreign Application Priority Data
Nov. 30, 2011 (TW) 100144077

(51) Int. Cl. G06F 13/20

(52) U.S. Cl. 710/300

(57) ABSTRACT

An electronic device includes an IOM and a BMC. The IOM includes at least one pair of ports, each port capable of being connected to an external device, and each pair of ports is configured for exchanging data between two external devices connected to two ports of the pair. The BMC is electrically connected to the IOM, to respond to a user input to provide an interface for the user to input commands to control a working mode of each pair of ports of the IOM.

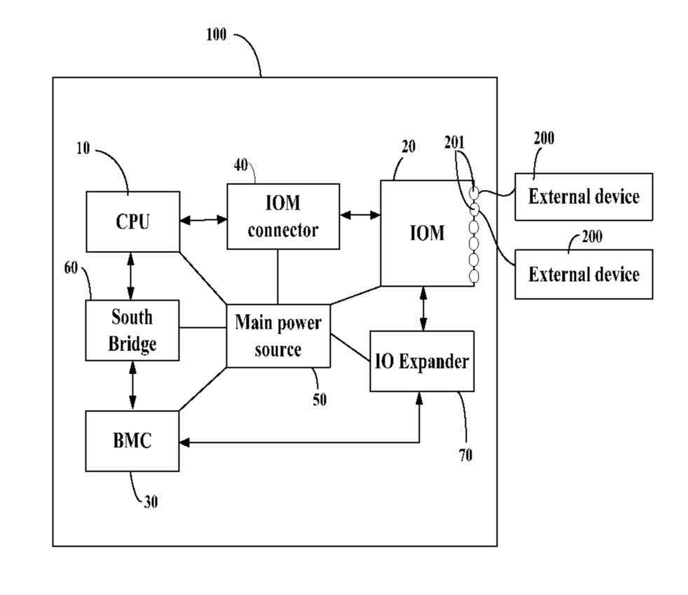

### BACKGROUND

1. Technical Field

The present disclosure relates to electronic devices with basement management controllers.

2. Description of Related Art

An electronic device capable of exchanging data, such as a server or a switch, usually includes a Central Processing Unit (CPU), a Baseboard Management Controller (BMC), and an Input-Output Module (IOM). The IOM is used to exchange data between two external devices. The CPU is electrically connected to the IOM. The IOM includes a number of pairs of ports, and each pair includes two ports, and each port can be connected to an external device. When a pair of ports is in a normal mode, two ports of the pair of ports are not directly connected to each other, and data transmitted from one external device should be received by the electronic device and then transmitted to the other external device. When a pair of ports is in a bypass mode, two ports of the pair of ports are directly connected to each other, and data transmitted from one external device can be directly transmitted to the other external device. When a pair of ports is in an open mode, data transmitted from one external device cannot be transmitted to the other external device. The mode of each pair of ports of the IOM can be controlled through the CPU when the device is working. However, when the CPU is shut down, the mode of each pair of ports of the IOM cannot be controlled.

### BRIEF DESCRIPTION OF THE DRAWINGS

The components of the drawing is not necessarily drawn to scale, the emphasis instead being placed upon clearly illustrating the principles of the present disclosure. Moreover, in the drawings, like reference numerals designate corresponding parts throughout several views.

The drawing is a schematic diagram showing a connection relationship among elements of an electronic device providing a path for a user to control a working mode of each pair of ports of an IOM of the electronic device, in accordance with an exemplary embodiment.

### DETAILED DESCRIPTION

Referring to the drawing, an electronic device 100 includes a Central Processing Unit (CPU) 10, an Input-Output Module (IOM) 20, and a Baseboard Management Controller (BMC) 30. The CPU 10 is connected to the IOM 20 by an IOM connector 40. The IOM 20 includes a number of pairs of ports 201. Each pair of ports 201 includes two ports. Each port is used to connect an external device 200. Each pair of ports 201 is used for exchanging data between the two external devices 200, which are respectively connected to the two ports of the pair of ports 201. Each pair of ports 201 has three working modes, for example, such as, a bypass mode, a normal mode, and an open mode.

When the device 100 is working, the CPU 10, the BMC 30, and the IOM 20 are all powered by a main power source 50, and the CPU 10 responds to a user input to provide an interface for the user to input commands to control the working modes of each pair of ports 201. For example, the user can input a command, such as “Get mode of pair N” to get the working mode of the pair N of the IOM 20, or “Set bypass mode of pair N” to set the pair N to be in a bypass mode.

The BMC 30 is connected to the CPU 10 through a South Bridge 60, such as an Intel P55 of Intel Corporation. The BMC 30 is used to detect parameters of the device 100, such as the temperature of the CPU 10, operating system status of the device 100, and power status, and send prompt messages to a system administrator of the device 100 if any of the detected parameters is out of a preset range. In this embodiment, the BMC 30 is an AST2150 chip.

In this embodiment, the BMC 30 is electrically connected to the IOM 20 to respond to a user input to provide an interface for the user to input commands to control the mode of each pair of port 201. The BMC 30 is connected to the IOM 20 by an Intelligent Platform Management Interface (IPMI) and through an I2C bus or a SMbus. In this embodiment, an IO Expander (Input-Output Expander) 70 connects the BMC 30 to the IOM 20. The Expander 70 is used to make the BMC 30 capable of being connected to different types of IOM 30. The Expander 70 is a PCA9535 chip. Therefore, even the CPU 10 is shut down, the working mode of each pair of ports 201 of the IOM 20 can also be controlled by the user.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device, comprising:
an Input-Output Module (IOM), the IOM comprising:
at least one pair of ports, each port being capable of being connected to an external device, and each pair of ports being configured for exchanging data between two external devices connected to two ports of the pair; and
a Baseboard Management Controller (BMC) electrically connected to the IOM, wherein the BMC responds to a user input to provide an interface for the user to input commands to control a mode of each pair of ports of the IOM.

2. The electronic device as described in claim 1, wherein the BMC is connected to the IOM through an IO Expander.

3. The electronic device as described in claim 1 further comprising a Central Processing Unit (CPU) electrically connected to the IOM, wherein the CPU responds to a user input to provide an interface for the user to input commands to control a mode of each pair of ports of the IOM.

4. The electronic device as described in claim 3, wherein the BMC is connected to the CPU through a South Bridge and the CPU is connected to the IOM through an IOM connector.

5. The electronic device as described in claim 1, wherein the BMC is connected to the IOM through an I2C bus or a SMbus.

6. The electronic device as described in claim 5, wherein the BMC is connected to the IOM though an Intelligent Platform Management Interface.

7. The electronic device as described in claim 1, wherein each pair of ports has three working modes, a bypass mode, a normal mode, and an open mode.
